(19) United States
(12) Patent Application Publication
(10) Pub. No.: US 2025/0206265 A1
(43) Pub. Date: Jun. 26, 2025

(54) AUTOMOTIVE RADAR SELECTION AND PLACEMENT

(71) Applicant: SNTNL LLC dba Canopy, Birmingham, MI (US)

(72) Inventors: Benjamin George Brown, Westland, MI (US); Tarik Alexander Safir, London (GB); Thandi Colley, London (GB)

(73) Assignee: SNTNL LLC dba Canopy, Birmingham, MI (US)

(21) Appl. No.: 18/392,884

(22) Filed: Dec. 21, 2023

(51) Int. Cl. B60R 25/31; B60R 25/10

(52) U.S. Cl. CPC B60R 25/31; B60R 25/1004; B60R 25/1018; B60R 2025/1016; B60R 2325/40

(57) ABSTRACT

Systems and methods are provided for monitoring and detecting unauthorized access to a vehicle. The systems and methods may receive surveillance data of the vehicle using a sensor. The systems and methods may detect, from the surveillance data, an intrusion to the vehicle by an entity. The systems and methods may transition the sensor out of a minimal power state upon detecting the intrusion to the vehicle. The systems and methods may perform a scan of the vehicle to obtain information indicating a type of the intrusion using the sensor. The systems and methods may determine, from the scan, the type of the intrusion to the vehicle is a threat intrusion by determining the entity causing the intrusion is unauthorized and the entity is performing an unauthorized action. The systems and methods may perform a safety action to interfere with the threat intrusion.

### TECHNICAL FIELD

The present disclosure relates generally to the field of automotive protection, and more particularly to systems and methods for automotive radar selection and placement to monitor and detect unauthorized access to an automotive.

### BACKGROUND OF THE INVENTION

Automotives may be used as a means of transportation for the public. Automotives may include motor vehicles, automobiles, trucks, motorcycles, bicycles, scooters, mopeds, recreational vehicles and other like on- or off-road vehicles. Automotives may further include autonomous, semi-autonomous and manual vehicles. As useful as an automotive is for the transportation of persons, automotives are also useful in the storage and transportation of other objects, both living (e.g., animals, insects, plants, etc.) and inanimate objects (e.g., furniture, clothes, books, appliances, etc.).

With automotives being a primary source of transportation, the security of an automotive, and any objects and property stored within, may be important to ensure the public's reliance and use of automotives. When an automotive is stationary, a person may rely more heavily on the security of the automotive to safekeep any objects and property left in the automotive. While most present automotives include security systems, most security systems do not have components necessary to actively monitor and detect unauthorized access to an automotive. This defect in the majority of current security systems may lead to incidents of trespassing and thief to occur with stationary automotives.

### BRIEF SUMMARY OF THE DISCLOSURE

According to various aspects of the disclosed technology, systems and methods for monitoring and detecting unauthorized access to a vehicle are provided.

In accordance with some implementations, a method for monitoring and detecting unauthorized access to a vehicle is provided. The method may include: receiving, by a sensor, surveillance data of the vehicle; detecting, from the surveillance data, an intrusion to the vehicle by an entity; transitioning the sensor out of a minimal power state upon detecting the intrusion to the vehicle; performing, using the sensor, a scan of the vehicle to obtain information indicating a type of the intrusion; determining, from the scan, the type of the intrusion to the vehicle is a threat intrusion; and performing a safety action to interfere with the threat intrusion.

In some applications, the sensor may be located on an apparatus for monitoring and detecting unauthorized access to the vehicle.

In some applications, the apparatus may be located on a vertical surface of the vehicle.

In some applications, the sensor may include at least one of a radar sensor, camera, image sensor, light detection and ranging (LiDAR) sensor, position sensor, audio sensor, infrared sensor, microwave sensor, optical sensor, haptic sensor, magnetometer, communication system and global positioning system (GPS).

In some applications, the detecting the intrusion to the vehicle by the entity may include determining, from the surveillance data, the entity is within a distance threshold from the vehicle.

In some applications, the determining the type of the intrusion is a threat intrusion may include: identifying, from the scan, the entity causing the intrusion to the vehicle; determining the entity is unauthorized based on the entity identification; and determining the entity is performing an unauthorized action to the vehicle.

In some applications, the determining the entity is unauthorized may include: analyzing the entity identification using Machine Learning (ML) algorithms; and determining the entity identification does not match the identity of an authorized entity to access the vehicle.

In some applications, the unauthorized action may include at least one of entering the vehicle, climbing on the vehicle, damaging the vehicle, removing items from the vehicle, and placing items into the vehicle.

In some applications, the safety action may include at least one of recording the intrusion, sounding an alarm, flashing lights, playing sounds, sending an alert, and shining projections.

In another aspect, a system for monitoring and detecting unauthorized access to a vehicle is provided that may include one or more processors; and memory coupled to the one or more processors to store instructions, which when executed by the one or more processors, may cause the one or more processors to perform operations. The operations may include: receiving, by a sensor, surveillance data of the vehicle; detecting, from the surveillance data, an intrusion to the vehicle by an entity; transitioning the sensor out of a minimal power state upon detecting the intrusion to the vehicle; performing, using the sensor, a scan of the vehicle to obtain information indicating a type of the intrusion; determining, from the scan, the type of the intrusion to the vehicle is a threat intrusion; and performing a safety action to interfere with the threat intrusion.

In some applications, the sensor may be located on an apparatus for monitoring and detecting unauthorized access to the vehicle.

In some applications, the apparatus may be located on a vertical surface of the vehicle.

In some applications, the sensor may include at least one of a radar sensor, camera, image sensor, light detection and ranging (LiDAR) sensor, position sensor, audio sensor, infrared sensor, microwave sensor, optical sensor, haptic sensor, magnetometer, communication system and global positioning system (GPS).

In some applications, the detecting the intrusion to the vehicle by the entity may include determining, from the surveillance data, the entity is within a distance threshold from the vehicle.

In some applications, the determining the type of the intrusion is a threat intrusion may include: identifying, from the scan, the entity causing the intrusion to the vehicle; determining the entity is unauthorized based on the entity identification; and determining the entity is performing an unauthorized action to the vehicle.

In some applications, the determining the entity is unauthorized may include: analyzing the entity identification using Machine Learning (ML) algorithms; and determining the entity identification does not match the identity of an authorized entity to access the vehicle.

In some applications, the unauthorized action may include at least one of entering the vehicle, climbing on the vehicle, damaging the vehicle, removing items from the vehicle, and placing items into the vehicle.

In some applications, the safety action may include at least one of recording the intrusion, sounding an alarm, flashing lights, playing sounds, sending an alert, and shining projections.

In another aspect, a non-transitory machine-readable medium is provided. The non-transitory computer-readable medium may include instructions that when executed by a processor may cause the processor to perform operations including: receiving, by a sensor, surveillance data of the vehicle; detecting, from the surveillance data, an intrusion to the vehicle by an entity; transitioning the sensor out of a minimal power state upon detecting the intrusion to the vehicle; performing, using the sensor, a scan of the vehicle to obtain information indicating a type of the intrusion; determining, from the scan, the type of the intrusion to the vehicle is a threat intrusion; and performing a safety action to interfere with the threat intrusion.

In some applications, the sensor may be located on an apparatus for monitoring and detecting unauthorized access to the vehicle.

In some applications, the apparatus may be located on a vertical surface of the vehicle.

In some applications, the sensor may include at least one of a radar sensor, camera, image sensor, light detection and ranging (LiDAR) sensor, position sensor, audio sensor, infrared sensor, microwave sensor, optical sensor, haptic sensor, magnetometer, communication system and global positioning system (GPS).

In some applications, the detecting the intrusion to the vehicle by the entity may include determining, from the surveillance data, the entity is within a distance threshold from the vehicle.

In some applications, the determining the type of the intrusion is a threat intrusion may include: identifying, from the scan, the entity causing the intrusion to the vehicle; determining the entity is unauthorized based on the entity identification; and determining the entity is performing an unauthorized action to the vehicle.

In some applications, the determining the entity is unauthorized may include: analyzing the entity identification using Machine Learning (ML) algorithms; and determining the entity identification does not match the identity of an authorized entity to access the vehicle.

In some applications, the unauthorized action may include at least one of entering the vehicle, climbing on the vehicle, damaging the vehicle, removing items from the vehicle, and placing items into the vehicle.

In some applications, the safety action may include at least one of recording the intrusion, sounding an alarm, flashing lights, playing sounds, sending an alert, and shining projections.

Other features and aspects of the disclosed technology will become apparent from the following detailed description, taken in conjunction with the accompanying drawings, which illustrate, by way of example, the features in accordance with applications of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various applications, is described in detail with reference to the following figures. The figures are provided for purposes of illustration only and merely depict typical or example applications.

FIG. 1 is an example illustration of a computing system for monitoring and detecting unauthorized access to a vehicle, according to example applications described in the present disclosure.

FIG. 2 is an example illustration of a device with which applications of the disclosed technology may be implemented.

FIG. 3 is an example illustration of the design of a device for monitoring and detecting unauthorized access to a vehicle, according to example applications described in the present disclosure.

FIG. 4 is an example illustration of a vehicle layout with which a device for monitoring and detecting unauthorized access to a vehicle may be installed, according to example applications described in the present disclosure.

FIG. 5 is an example illustration of a point of view of a device for monitoring and detecting unauthorized access to a vehicle, according to example applications described in the present disclosure.

FIGS. 6A and 6B are example illustrations of a point of view of a device for monitoring and detecting unauthorized access to a vehicle, according to example applications described in the present disclosure.

FIG. 7 is an example illustration of a computing component that includes one or more hardware processors and machine-readable storage media storing a set of machine-readable/machine-executable instructions that, when executed, cause the one or more hardware processors to perform an illustrative method for monitoring and detecting unauthorized access to a vehicle, according to example embodiments described in the present disclosure.

FIG. 8 is an example illustration of a computing component that may be used to implement various features of embodiments described in the present disclosure.

The figures are not exhaustive and do not limit the present disclosure to the precise form disclosed.

### DETAILED DESCRIPTION

As described above, automotives may be used as a means of transportation for the public. As useful as an automotive is for the transportation of persons, automotives are also useful in the storage and transportation of other objects, both living (e.g., animals, insects, plants, etc.) and inanimate objects (e.g., furniture, clothes, books, appliances, etc.). When an automotive is stationary, a person may rely on the security of the automotive to safekeep any objects and property left in the automotive. While most present automotives include security systems, most security systems do not have components necessary to actively monitor and detect unauthorized access to an automotive, which may lead to incidents of trespassing and thief to occur with stationary automotives.

Aspects of the technology disclosed herein may provide systems and methods configured to monitor and detect unauthorized access to a vehicle. A vehicle may be used as a means of storage and transportation of objects, both living (e.g., animals, insects, plants, etc.) and inanimate objects (e.g., furniture, clothes, books, appliances, etc.), as well as a means of transportation of persons. The vehicle may include, for example, an automobile, truck, motorcycle, bicycle, scooter, moped, recreational vehicle and other like on- or off-road vehicles. The vehicle may include, for example, an autonomous, semi-autonomous and manual operation. The vehicle may include one or more devices that may be used to monitor the vehicle and detect any intrusions to the vehicle. A device for monitoring surveillance and detecting intrusions may be implemented on a vertical facing surface of the vehicle, including, for example, the surface of a vertical internal frame, the surface of a vertical external frame, the surface of a rear window, etc. of the vehicle. Many variations are possible.

A device for monitoring surveillance and detecting intrusions may include one or more sensors that may be used to collect data of the surveillance of the vehicle. The sensors may include, for example, a radar sensor, camera, image sensor, light detection and ranging (LiDAR) sensor, position sensor, audio sensor, infrared sensor, microwave sensor, optical sensor, haptic sensor, magnetometer, communication system and global positioning system (GPS). A radar sensor may include, for example, a pulsed radar, continuous wave radar, frequency modulated continuous wave (FMCW) radar (e.g., Infineon 60 GHz BGT60TR13C radar), bistatic radar, doppler radar, monopulse radar, passive radar, instrumentation radar, mapping radar, search radar, etc. Data may be received by at least one sensor of the device. The data of the surveillance of the vehicle may include information on persons, objects and other vehicles within a vicinity of the vehicle, including within and outside the vehicle. Many variations are possible.

The data of the surveillance of the vehicle may be analyzed by the device upon being collected by at least one sensor of the device. Analyzing the data of the surveillance of the vehicle may detect one or more intrusions to the vehicle by one or more entities. An intrusion to the vehicle may include, for example, when an entity comes within a particular vicinity of the vehicle. The particular vicinity of the vehicle may be within a distance threshold from the vehicle. The distance threshold may be preset. The distance threshold may vary according to the location of the vehicle, such as, for example, the vehicle is stationary in a parking garage, side of the road, open lot, etc. The distance threshold may be updated according to algorithms and models using security data of vehicles. An entity may include persons, objects and other vehicles not already associated with the vehicle. An entity may be associated with the vehicle when the entity is contained within the vehicle prior to the surveillance of the vehicle by the device. Many variations are possible.

When the device for monitoring the surveillance and detecting intrusions to the vehicle is first initiated, the device may implement a minimal power state to its one or more sensors. The sensors being in a minimal power state may allow the sensors to be active and functioning for longer durations. The sensors being in a minimal power state may also limit the abilities and functions of the sensors to lower the amount of power being consumed by the sensors, thus allowing the sensors to be active and functioning for longer durations.

The sensors may stay in a minimal power state until the sensors are woken up and transitioned out of the minimal power state. Detecting an intrusion to the vehicle by an entity may cause the device to transition the one or more sensors of the device out of the minimal power state. When the sensors are out of the minimal power state, the sensors may be fully functional with all of its abilities and functions. The sensors may also consume more power when out of the minimal power state and be active and functioning for shorter durations. To preserve power and maintain optimal durations of use of the sensors, the device may transition the sensors back to the minimal power state when an intrusion is no longer detected and when an intrusion is determined to be authorized.

After the sensors have transitioned out of the minimal power state, the sensors may have full functionality allowing the use of functions to perform a scan of the vehicle. The sensors may perform a scan of the vehicle and everything inside and outside of the vehicle that is within a vicinity of the vehicle. The vicinity of the vehicle that the scan of the sensors may cover may be preset. The vicinity of the vehicle may vary according to the location of the vehicle, such as, for example, the vehicle is stationary in a parking garage, side of the road, open lot, etc. The vicinity of the vehicle may be updated according to algorithms and models using security data of vehicles. The vicinity of the vehicle may be the same as the distance threshold from the vehicle that is used to detect the occurrence of an intrusion to the vehicle. Performing a scan of the vehicle may allow the sensors to obtain information about the intrusion that is occurring to the vehicle, including, for example, information on the one or more entities causing the intrusion, information on the actions that the one or more entities are performing, etc. Many variations are possible.

The information about the intrusion may be analyzed to determine the type of the intrusion. The type of the intrusion may include, for example, a safe intrusion and a threat intrusion. A safe intrusion may be an intrusion caused by an entity who is authorized to access the vehicle. A safe intrusion may be an intrusion caused by an entity that is identified to be harmless to the vehicle. A threat intrusion may be an intrusion caused by an entity that is identified as being unauthorized to access the vehicle. A threat intrusion may be an intrusion caused by an entity that is identified as being harmful to the vehicle. Many variations are possible.

As the sensors of the device for monitoring the surveillance and detecting intrusions to the vehicle are performing a scan of the vehicle, the sensors may collect information about the intrusion that is occurring to the vehicle. The information about the intrusion may include, for example, information on the one or more entities causing the intrusion, information on the actions that the one or more entities are performing, etc. The information about the intrusion may be analyzed to determine the type of the intrusion, such as, for example, a safe intrusion or a threat intrusion.

To determine the type of the intrusion is a threat intrusion, the information about the intrusion obtained from the scan may be analyzed. The information about the intrusion may be analyzed to first identify the one or more entities causing the intrusion to the vehicle. In one example, each of the one or more entities may be identified as a person, animal, object, etc. An entity may be identified by analyzing the information about the intrusion to obtain the identity of the entity, such as, for example, the facial recognition of the entity. After an entity is identified, it may be determined if the entity is unauthorized to access the vehicle. Determining if the entity is unauthorized to access the vehicle may include analyzing the entity's identification using ML algorithms, models, databases, servers, and the like to determine the entity's identification does not match the identify of an authorized entity to access the vehicle. Such ML algorithms, models, databases, servers, etc. may include information, such as, for example, facial recognition, of entities that are authorized to access the vehicle. In another example, the information about the intrusion may be analyzed to determine if at least one of the one or more entities causing the intrusion is a person. If at least one of the one or more entities causing the intrusion is determined to be a person, it may be determined that all of the one or more entities causing the intrusion are unauthorized entities. Many variations are possible.

Upon determining at least one entity is an unauthorized entity, the information about the intrusion may be further analyzed to determine if the unauthorized entity is performing an unauthorized action to the vehicle. In one example, if at least one entity is determined to be unauthorized based on the analysis of the entity's identification, it may be determined if the entity is performing an unauthorized action to the vehicle. An unauthorized action may include, for example, entering the vehicle, climbing on the vehicle, damaging the vehicle, removing items from the vehicle, and placing items into the vehicle. When it is determined that an unauthorized entity is performing an unauthorized action to the vehicle, then the type of the intrusion may be determined to be a threat intrusion. If the entity is determined to be authorized based on the analysis of the entity's identification, then the type of the intrusion may be determined to be a safe intrusion. If the entity is determined to be unauthorized, but it is determined that the unauthorized entity is not performing an unauthorized action to the vehicle, then the type of the intrusion may be determined to be a safe intrusion. Many variations are possible.

Upon determining the type of the intrusion to be a threat intrusion, one or more safety actions may be performed. A safety action may include, for example, recording the intrusion, sounding an alarm, flashing lights, playing sounds, sending an alert, and shining projections. Recording the intrusion may include, for example, at least one of recording a video, taking photos, recording audio, etc. The safety action may be performed by the device for monitoring the surveillance and detecting intrusions to the vehicle. The safety action may be performed by the vehicle that the device for monitoring the surveillance and detecting intrusions to the vehicle is associated to. The safety action of an alert may also be sent to another device (e.g., a user device of the vehicle owner) and network/system (e.g., police network, home network, work network, vehicle security network, etc.) to notify of the threat intrusion. The alert may include, for example, a message, recordings, sounds, GPS location, identifications, etc. of information regarding the threat intrusion to the vehicle. Many variations are possible.

In this way, active surveillance may be performed on a vehicle to properly monitor and detect the occurrence of any intrusions on the vehicle. This may be beneficial to vehicle owners by increasing the security and protection of a vehicle and any property, persons and objects left within the vehicle. The active detection and response to unauthorized intrusions and access to a vehicle may also deter break ins, theft, vandalism, and other inappropriate acts to be performed to a vehicle. The active detection and response to unauthorized intrusions and access to a vehicle may also increase the likelihood of criminals to be caught and punished for their crimes.

It should be noted that the terms “accurate,” “accurately,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

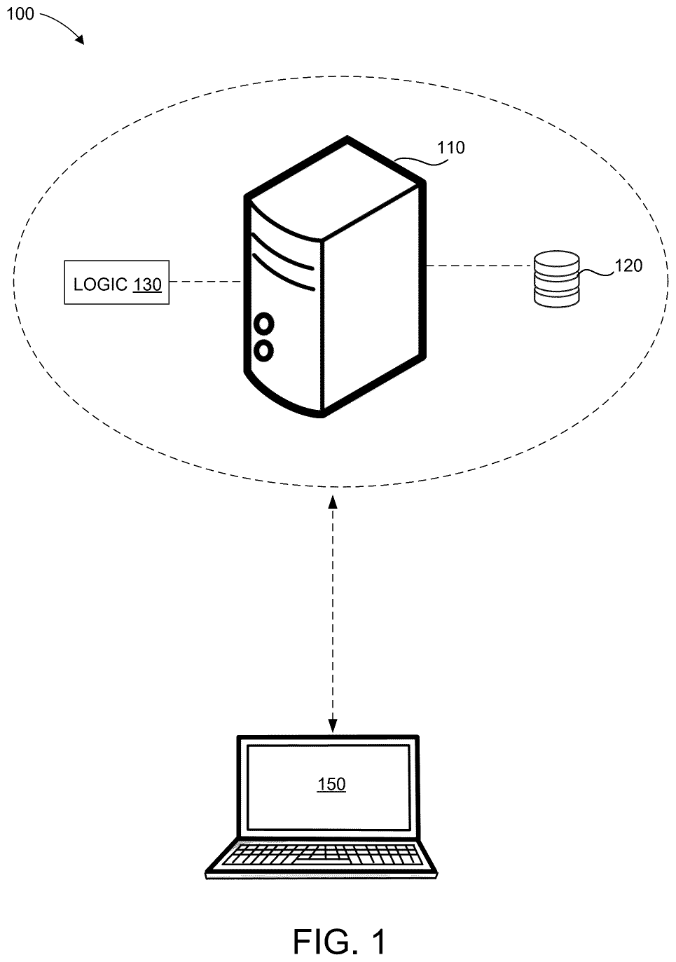

FIG. 1 illustrates an example of a computing system 100 which may be internal or otherwise associated within a device 150. In some embodiments, the computing system 100 may be a machine learning (ML) pipeline and model, and use ML algorithms. In some examples, the device 150 may be a computing device, such as a desktop computer, a laptop, a mobile phone, a tablet device, an Internet of Things (IoT) device, etc. The device 150 may input data into computing component 110. The computing component 110 may perform one or more available operations on the input data to generate outputs, such as monitoring and detecting unauthorized access to a vehicle. The device 150 may further display the outputs on a Graphical User Interface (GUI). The GUI may be on device 150 or another computing device, and may display the outputs as an image, video recording, and two dimensional (2D) and three dimensional (3D) layout showing the various outputs generated by algorithms, such as ML algorithms, based on various input data, such as sensor data of the surveillance of a vehicle.

The computing system 100 in the illustrated example may include one or more processors and logic 130 that implements instructions to carry out the functions of the computing component 110, for example, receiving surveillance data of the vehicle, detecting an intrusion to the vehicle by an entity, transitioning the sensor out of a minimal power state upon detecting the intrusion to the vehicle, performing a scan of the vehicle to obtain information indicating a type of the intrusion, determining the type of the intrusion to the vehicle is a threat intrusion, and performing a safety action to interfere with the intrusion. The computing component 110 may store, in a database 120, details regarding scenarios or conditions in which some algorithms, image datasets, and assessments are performed and used to monitor and detect unauthorized access to a vehicle. Some of the scenarios or conditions will be illustrated in the subsequent figures.

A processor may include one or more GPUs, CPUs, microprocessors or any other suitable processing system. Each of the one or more processors may include one or more single core or multicore processors. The one or more processors may execute instructions stored in a non-transitory computer readable medium. Logic 130 may contain instructions (e.g., program logic) executable by the one or more processors to execute various functions of computing component 110. Logic 130 may contain additional instructions as well, including instructions to transmit data to, receive data from, and interact with device 150.

ML can refer to methods that, through the use of algorithms, are able to automatically extract intelligence or rules from training data sets and capture the same in informative models. In turn, those models are capable of making predictions based on patterns or inferences gleaned from subsequent data input into a trained model. According to implementations of the disclosed technology, the ML algorithm comprises, among other aspects, algorithms implementing a Gaussian process and the like. The ML algorithms disclosed herein may be supervised and/or unsupervised depending on the implementation. The ML algorithms may emulate the observed characteristics and components of vehicles, persons, and objects to better monitor vehicle surveillance, and determine unauthorized entities and actions to accurately detect unauthorized access to a vehicle.

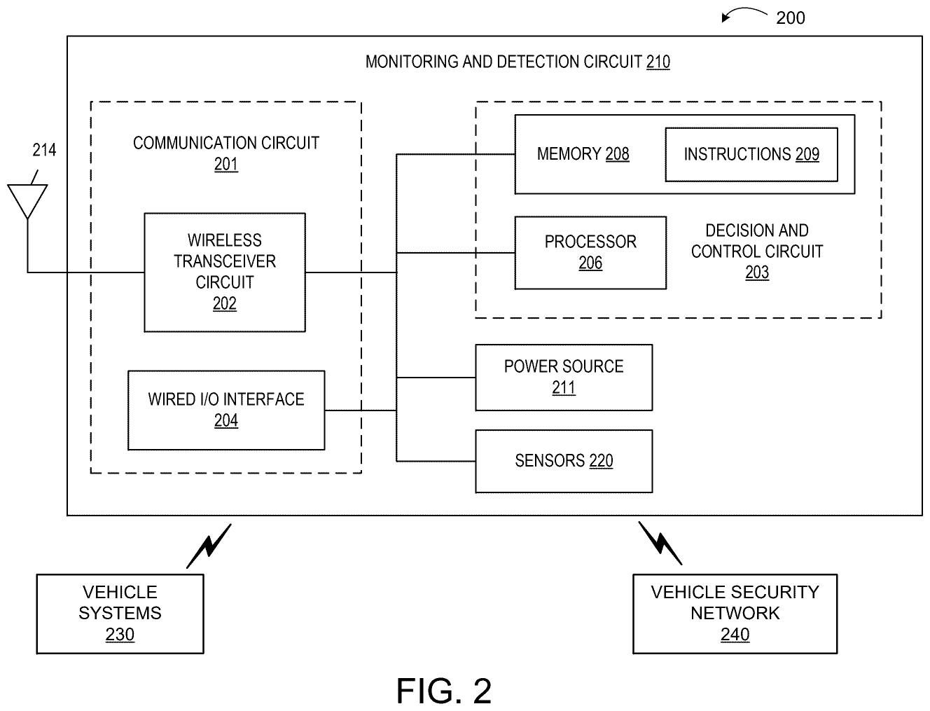

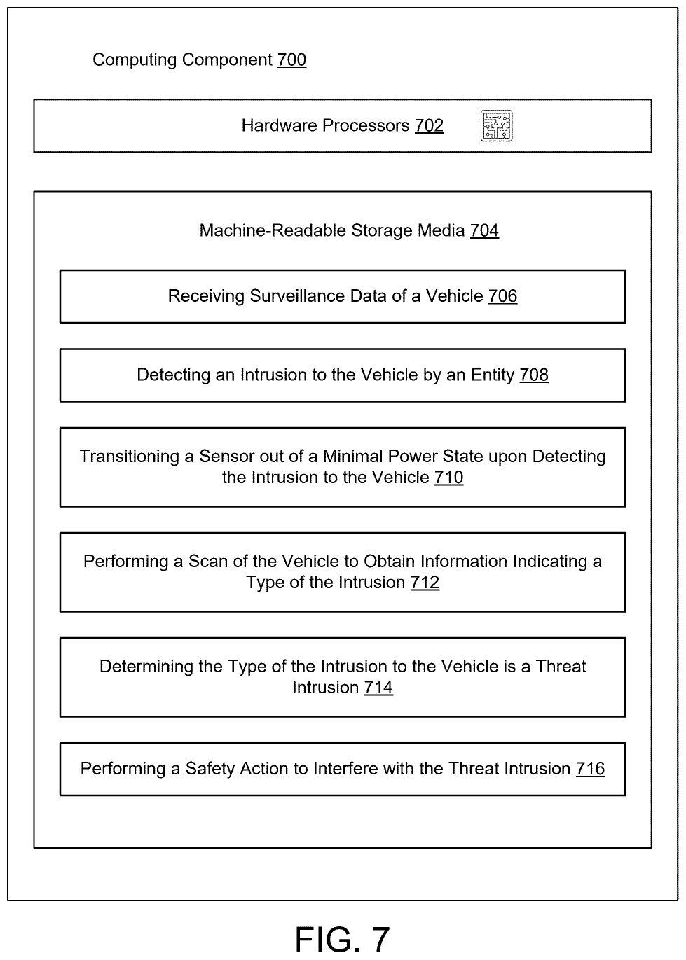

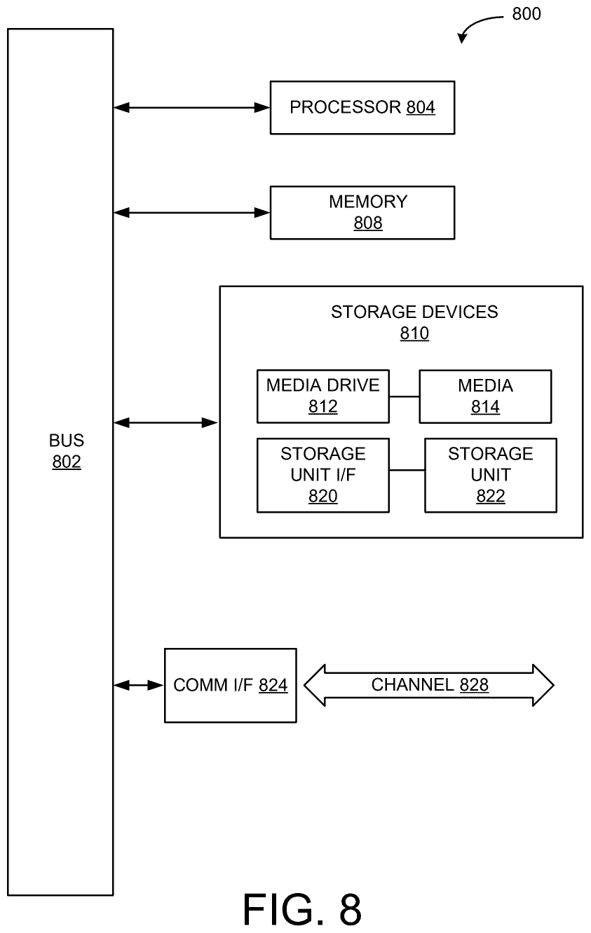

Although one example computing system 110 is illustrated in FIG. 1, in various embodiments multiple computing systems 110 can be included. Additionally, one or more systems and subsystems of computing system 100 can include its own dedicated or shared computing component 110, or a variant thereof. Accordingly, although computing system 100 is illustrated as a discrete computing system, this is for ease of illustration only, and computing system 100 can be distributed among various systems or components. The computing component 110 may be, for example, the monitoring and detection circuit 210 of FIG. 2, the computing component 700 of FIG. 7 and the computing component 800 of FIG. 8.

FIG. 2 illustrates an example architecture of a device 200 for monitoring and detecting unauthorized access to a vehicle as described herein. Referring now to FIG. 2, in this example, a device 200 includes a monitoring and detection circuit 210, a communication circuit 201, a decision and control circuit 203, a power source 211, and a plurality of sensors 220. Also included are various elements of vehicle systems 230 and a vehicle security network 240 with which the monitoring and detection device 200 can communicate. It can be understood that a vehicle security network 240 can include various elements that are important in a vehicle security network, such as vehicles, persons (with or without connected devices that can include aspects of monitoring and detection device 200 disclosed herein), or infrastructure (e.g. sensors, such as radars, cameras, central servers, databases, etc.). Other elements of the vehicle security network 240 can include connected elements at workplaces, or the home (such as vehicle chargers, connected devices, appliances, etc.).

Monitoring and detection device 200 can be implemented as and include one or more components of a vehicle. Vehicle systems 230 and elements of vehicle security network 240 can communicate with the a monitoring and detection circuit 210 via a wired or wireless communication interface. As previously alluded to, elements of vehicle security network 240 can correspond to connected or unconnected devices, infrastructure (e.g. sensors, such as radars, cameras, central servers, databases, etc.), vehicles, persons, objects, etc. that are in a broad or immediate vicinity of a vehicle or otherwise important to the vehicle security network. Although vehicle systems 230 and vehicle security network 240 are depicted as communicating with monitoring and detection circuit 210, they can also communicate with each other, as well as with other vehicle systems and directly with an element of a vehicle security network.

Data as disclosed herein can be communicated to and from the monitoring and detection circuit 210. For example, various infrastructure (example element of vehicle security network 240) can include one or more databases, such as vehicle infrastructure data or person identification data. This data can be communicated to the circuit 210, and such data can be updated based on outcomes from one or more actions or changes to the vehicle security network, vehicle system, and security data from sensors 220 (e.g. detection of intrusion and unauthorized persons) of the vehicle. All of this data can be included in and contribute to predictive analytics (e.g., by machine learning) of intrusion possibility, and determinations of unauthorized persons and unauthorized access to a vehicle. Similarly, models, circuits, and predictive analytics can be updated according to various outcomes.

Monitoring and detection circuit 210 can evaluate surveillance data of a vehicle, identifications of persons, actions occurring to the vehicle, and determine unauthorized access is occurring to the vehicle to perform a security response as described herein. As will be described in more detail herein, the detection of unauthorized access can have one or more contributing factors. Various sensors 220, vehicle systems 230, and vehicle security network 240 elements may contribute to gathering data for evaluating possible intrusions and detecting an unauthorized access to a vehicle. For example, the monitoring and detection circuit 210 can include at least one of a decision and control circuit 203 that may be used to evaluate gathered data. The monitoring and detection circuit 210 can be implemented as an electronic control unit (ECU) or as part of an ECU. In other applications, monitoring and detection circuit 210 can be implemented independently of an ECU, for example, as another vehicle system.

Monitoring and detection circuit 210 can be configured to evaluate intrusions, detect unauthorized access, and appropriately respond. Monitoring and detection circuit 210 may include a communication circuit 201 (including either or both of a wireless transceiver circuit 202 with an associated antenna 214 and wired input/output (I/O) interface 204 in this example), a decision and control circuit 203 (including a processor 206 and memory 208 in this example), a power source 211 (which can include power supply or connect to an external power supply, such as, for example, the power supply of a vehicle), and sensors 220. It is understood that the disclosed monitoring and detection circuit 210 can be compatible with and support one or more standard or non-standard messaging protocols.

Components of monitoring and detection circuit 210 are illustrated as communicating with each other via a data bus, although other communication in interfaces can be included. Decision and control circuit 203 can be configured to control one or more aspects of unauthorized access detection and response. Decision and control circuit 203 can be configured to execute one or more steps described with reference to FIG. 7.

Processor 206 can include a GPU, CPU, microprocessor, or any other suitable processing system. Processor 206 may include one or more single core or multicore processors. Processor 206 executes instructions 209 stored in a non-transitory computer readable medium, such as memory 208. Memory 208 may contain instructions 209 (e.g., program logic) executable by processor 206 to execute various functions of monitoring and detection device 200, including those of vehicle systems and subsystems. Memory 208 may contain additional instructions as well, including instructions to transmit data to, receive data from, interact with, and control one or more of the sensors 220, AV control systems and vehicle systems 230. In addition to the instructions, memory 208 may store data and other information used by the monitoring and detection device 200 and its systems and subsystems for operation. For example, memory 208 can include data that has been communicated to the vehicle (e.g. via V2X communication), security data, vehicle dynamics data, computer vision recognition data, and other data which can be useful for the execution of one or more intrusion detection, person identification and unauthorized access verification.

The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions 209 that may be used by the processor 206 to execute one or more functions of monitoring and detection circuit 210. For example, data and other information can include vehicle infrastructure data, such as the parameters of a vehicle. The data can also include values for signals of one or more sensors 220 useful in detecting and verifying unauthorized access to a vehicle. Operational instruction 209 can contain instructions for executing logical circuits, models, and methods as described herein.

Although the example of FIG. 2 is illustrated using processor and memory circuitry, as described below with reference to circuits disclosed herein, decision and control circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a monitoring and detection circuit 210. Components of decision and control circuit 203 can be distributed among two or more decision and control circuits 203, performed on other circuits described with respect to monitoring and detection circuit 210, be performed on devices (such as radars, cell phones) performed on a cloud-based platform (e.g. part of infrastructure), performed on distributed elements of the vehicle security network 240, such as at multiple vehicles, devices, central servers, performed on an edge-based platform, and performed on a combination of the foregoing.

Communication circuit 201 may include either or both a wireless transceiver circuit 202 with an associated antenna 214 and a wired I/O interface 204 with an associated hardwired data port (not illustrated). As this example illustrates, communications with monitoring and detection circuit 210 can include either or both wired and wireless communications circuits 201. Wireless transceiver circuit 202 can include a transmitter and a receiver (not shown), e.g., a monitoring and detection broadcast mechanism, to allow wireless communications via any of a number of communication protocols such as, for example, WiFi (e.g. IEEE 802.11 standard), Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by monitoring and detection circuit 210 to/from other components of the vehicle, such as sensors 220, vehicle systems 230, infrastructure (e.g. servers cloud based systems), and other devices or elements of vehicle security network 240. These RF signals can include information of almost any sort that is sent or received by vehicle.

Wired I/O interface 204 can include a transmitter and a receiver (not shown) for hardwired communications with other devices. For example, wired I/O interface 204 can provide a hardwired interface to other components, including sensors 220, vehicle systems 230, and vehicle security network 240. Wired I/O interface 204 can communicate with other devices using Ethernet or any of a number of other wired communication protocols whether standardized, proprietary, open, point-to-point, networked or otherwise.

Power source 211 may include one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, another vehicle battery, alternator, etc.), an energy harvester (e.g., solar cells, piezoelectric system, etc.), or it can include any other suitable power supply. It is understood power source 211 can be coupled to a power source of the vehicle, such as a battery and alternator. Power source 211 can be used to power the monitoring and detection circuit 210.

Sensors 220 can include one or more sensors that may or not otherwise be included on a standard vehicle (e.g., vehicle 400) with which the monitoring and detection device 200 is implemented. Sensors 220 may include radar sensors, cameras, image sensors, light detection and ranging (LIDAR) sensors, position sensors, audio sensors, infrared sensors, microwave sensors, optical sensors, haptic sensors, magnetometers, communication systems and global positioning systems (GPS). Radar sensors of sensor 220 may include, for example, pulsed radars, continuous wave radars, frequency modulated continuous wave (FMCW) radars (e.g., Infineon 60 GHz BGT60TR13C radar), bistatic radars, doppler radars, monopulse radars, passive radars, instrumentation radars, mapping radars, search radars, etc. Additional sensors can also be included as may be appropriate for a given implementation of monitoring and detection device 200.

Vehicle systems 230 can include any of a number of different vehicle components or subsystems used to control or monitor various aspects of the vehicle and its performance. Vehicle systems 230 include, for example, a steering system, throttle system, brakes, transmission, electronic control unit (ECU), propulsion system, vehicle hardware interfaces, and vehicle security system. The vehicle security system of vehicle systems 230 may control components, such as sensors, of a vehicle to monitor and collect surveillance data of the vehicle.

The vehicle systems 230 may be controlled by AV control systems in autonomous, semi-autonomous or manual mode of a vehicle. For example, in autonomous or semi-autonomous mode, AV control systems, alone or in conjunction with other systems, can control vehicle systems 230 to operate the vehicle in a fully or semi-autonomous fashion. When control is assumed, a computing system and AV control system can provide vehicle control systems to vehicle hardware interfaces for controlled systems such as steering angle, brakes, throttle, or other hardware interfaces, such as traction force, turn signals, horn, lights, etc. This may also include an assist mode in which the vehicle takes over partial control or activates ADAS controls (e.g. AC control systems) to assist the driver with vehicle operation. The vehicle systems 230 may include a GPS or other vehicle positioning system.

During operation, monitoring and detection circuit 210 can receive information from various sensors 220, vehicle systems 230, and vehicle security network 240 to detect unauthorized access to a vehicle. Also, the driver, owner, and operator of the vehicle may manually trigger one or more processes described herein for detecting and verifying an unauthorized access to the vehicle. Communication circuit 201 can be used to transmit and receive information between the monitoring and detection circuit 210, sensors 220 and vehicle systems 230. Also, sensors 220 and monitoring and detection circuit 210 may communicate with vehicle systems 230 directly or indirectly (e.g., via communication circuit 201 or otherwise). Communication circuit 201 can be used to transmit and receive information between monitoring and detection circuit 210, one or more other systems of a vehicle, but also other elements of a vehicle security network 240, such as vehicles, persons, devices (e.g. mobile phones), systems, networks (such as a communications network and central server), and infrastructure.

In various applications, communication circuit 201 can be configured to receive data and other information from sensors 220 and vehicle systems 230 that is used in monitoring and detecting unauthorized access to a vehicle. As one example, when data is received from a an element of vehicle security network 240 (such as from a vehicle owner's user device), communication circuit 201 can be used to send an activation signal and activation information to one or more vehicle systems 230 or sensors 220 for the monitoring and detection device 200 to detect unauthorized access to the vehicle. For example, it may be useful for vehicle systems 230 or sensors 220 to provide data useful in monitoring and detecting an intrusion to the vehicle to determine if an unauthorized access to the vehicle is occurring. Alternatively, monitoring and detection circuit 210 can be continuously receiving information from vehicle system 230, sensors 220, other vehicles, devices and infrastructure (e.g. those that are elements of vehicle security network 240).

In some applications upon detecting an intrusion, the decision and control circuit 203 of the monitoring and detection device 200 may determine the type of the intrusion. Depending on the type of the intrusion, the decision and control circuit 203 may implement one or more operations. For example, upon determining the type of the intrusion is a threat, the decision and control circuit 203 may provide instructions for sensors 220 to perform a scan of the vehicle to obtain data of all persons and objects within the vicinity of the vehicle. The decision and control circuit 203, along with other components, such as, for example, vehicle systems 230 and vehicle security network 240, may analyze the data of the scan to determine if an unauthorized access to the vehicle is detected. Upon detecting an unauthorized access to the vehicle, communication circuit 201 can send a signal to other components of the vehicle, infrastructure, user device, or other elements of the vehicle security network 240 based on the detection of the unauthorized access. For example, the communication circuit 201 can send a signal to a vehicle system 230 that indicates a control input for performing one or more security actions, such as, for example, sounding an alarm, flashing lights, playing sounds, sending an alert, and shining projections. In another example, the communication circuit 201 can send a signal to a device (e.g., the vehicle owner's user device) that indicates an unauthorized access is occurring to the vehicle. In another example, the communication circuit 201 can send a signal to sensors 220 to perform one or more security actions, such as, for example, recording the unauthorized access, sounding an alarm, flashing lights, playing sounds, sending an alert, and shining projections.

The examples of FIG. 2 are provided for illustration purposes only as examples of monitoring and detection device 200 with which applications of the disclosed technology may be implemented. One of ordinary skill in the art reading this description will understand how the disclosed applications can be implemented with vehicle platforms.

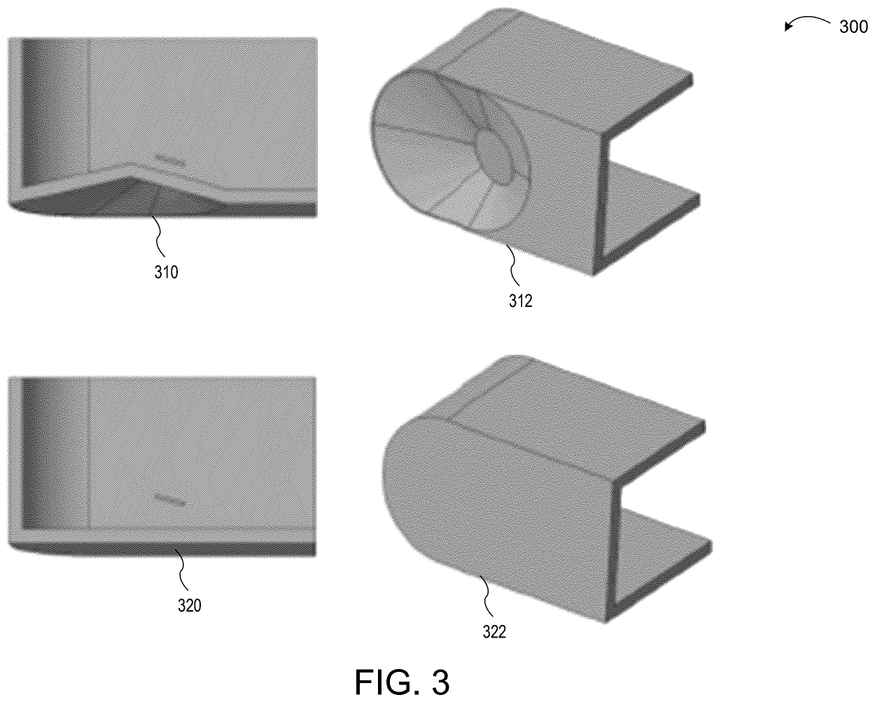

FIG. 3 illustrates example designs of the monitoring and detection device 300. The monitoring and detection device 300 may be the monitoring and detection device 200 of FIG. 2. The monitoring and detection device 300 may be designed with a radome that is constructed with material that may allow the transmission of energy signals, such as, for example, radio waves. The radome may be a structural and weatherproof enclosure that protects components of the monitoring and detection device 300, such as, for example, the antenna (e.g., antenna 214).

The radome of the monitoring and detection device 300 may in designed in a plurality of different shapes, including, for example, cone shaped, square shaped, flat shaped, etc. The shape of the radome may be determined according to one or more sensors used for the monitoring and detection device 300. The shape of the radome may be determined according to the degree of performance a particular radome shape will allow for a particular sensor(s) for the monitoring and detection device 300. Radome designs 310 and 312 represent an example of a cone shaped radome, with radome designs 310 and 312 each displaying different points of view of the cone shaped radome. Radome designs 320 and 322 represent an example of a flat shaped radome, with radome designs 320 and 322 each displaying different points of view of the flat shaped radome.

The monitoring and detection device 300 may be designed with a plurality of different materials, including, for example, polycarbonate. The material used for the monitoring and detection device 300 may be determined according to types of sensors used with the monitoring and detection device 300. The material used for the monitoring and detection device 300 may be determined based on the attributes that the monitoring and detection device 300 may be required to have to provide optimal results in surveillance and intrusion detection of a vehicle. Attributes of the monitoring and detection device 300 that may contribute to providing optimal results in surveillance and intrusion detection of a vehicle may include, for example, material thickness, material durability, strength and ability of energy signal transmissions (e.g., radar transmission), etc.

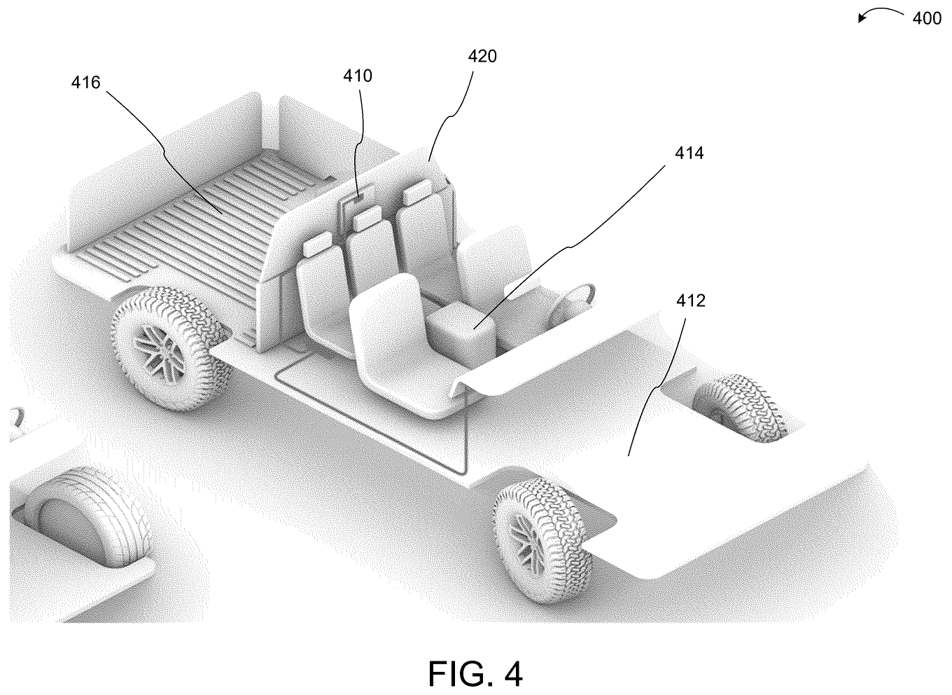

FIG. 4 illustrates an example diagram of the internal structure of a vehicle 400 that may include a monitoring and detection device 410. The monitoring and detection device 410 may be the monitoring and detection device 200 of FIG. 2 and the monitoring and detection device 300 of FIG. 3. The vehicle 400 may be, for example, an automobile, truck, motorcycle, bicycle, scooter, moped, recreational vehicle and other like on- or off-road vehicles. The vehicle 400 may include multiple compartments, including, for example, an engine compartment 412, a passenger compartment 414 and a luggage compartment 416 (e.g., a truck bed). The passenger compartment 414 and the luggage compartment 416 may be separated by a vertical surface 420, which may include, for example, a rear window.

The monitoring and detection device 410 may be mounted on the vehicle 400 on any surface of the vehicle, including, for example, the vertical surface 420. The monitoring and detection device 410 may be mounted on a surface of the vehicle that is external or internal to the vehicle. For example, the monitoring and detection device 410 may be mounted on the vertical surface 420 of vehicle 400. The monitoring and detection device 410 may be mounted on the side of the vertical surface 420 that is in the passenger compartment 414, which may be considered as internal to the vehicle 400. The monitoring and detection device 410 may be mounted on the vertical surface 420 using a component or material, such as, for example, adhesive tape, that may allow the monitoring and detection device 410 to stay attached to the vertical surface 420. The monitoring and detection device 410 may be mounted to the vertical surface 420 such that the sensors of the monitoring and detection device 410 are facing towards the luggage compartment 416 or the passenger compartment 414 of the vehicle 400. The monitoring and detection device 410 may be mounted at any location on a vertical surface of a vehicle, such as, for example, the center of vertical surface 420 of vehicle 400. Many variations are possible.

The monitoring and detection device 410 may also be interconnected, either wirelessly or wired, to the vehicle 400. The monitoring and detection device 410 may be interconnected to the vehicle 400 to connect to a power source of the vehicle 400, such as, for example, a battery and alternator. The monitoring and detection device 410 may be interconnected to the vehicle 400 to communicate with one or more components of the vehicle 400, such as, for example, sensors, vehicle systems (e.g., vehicle systems 230 of FIG. 2) and vehicle security networks (e.g., vehicle security networks 240 of FIG. 2). Many variations are possible.

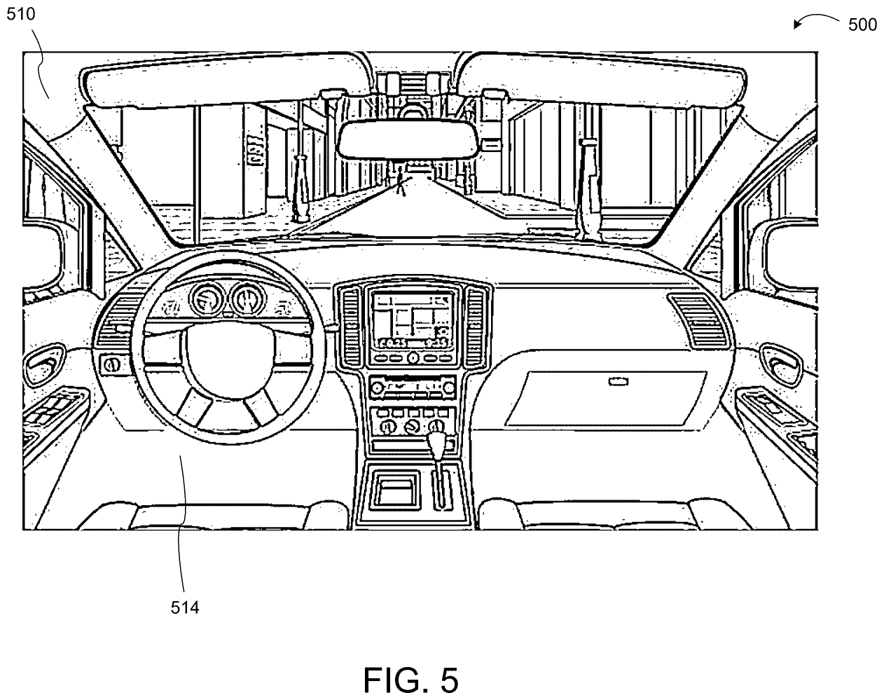

FIG. 5 illustrates an example image 500 of a point of view from the monitoring and detection device. Image 500 may display a point of view from the monitoring and detection device, such as, for example, monitoring and detection device 410 of FIG. 4, when the device is mounted to a vertical surface of a vehicle 510, such as, for example, vertical surface 420 of vehicle 400 of FIG. 4. Image 500 may display the passenger compartment 514 of a vehicle 510 from the point of view of the monitoring and detection device. The passenger compartment 514 of vehicle 510 may be the passenger compartment 414 of vehicle 400 of FIG. 4. The monitoring and detection device mounted to vehicle 510 may use one or more sensors to capture image 500 of vehicle 510 when performing surveillance and intrusion detection of the vehicle 510. The monitoring and detection device may capture other images of the passenger compartment 514 of vehicle 510 when an intrusion is detected. The monitoring and detection device may monitor the passenger compartment 514 of the vehicle 510 to safeguard any property, persons and objects that are stored in the passenger compartment 514 of the vehicle 510. If the monitoring and detection device detects a threat intrusion occurring in the passenger compartment 514 of the vehicle 510, the monitoring and detection device may analyze data of the passenger compartment 514 of vehicle 510 to determine if any property, persons and objects have been removed and added.

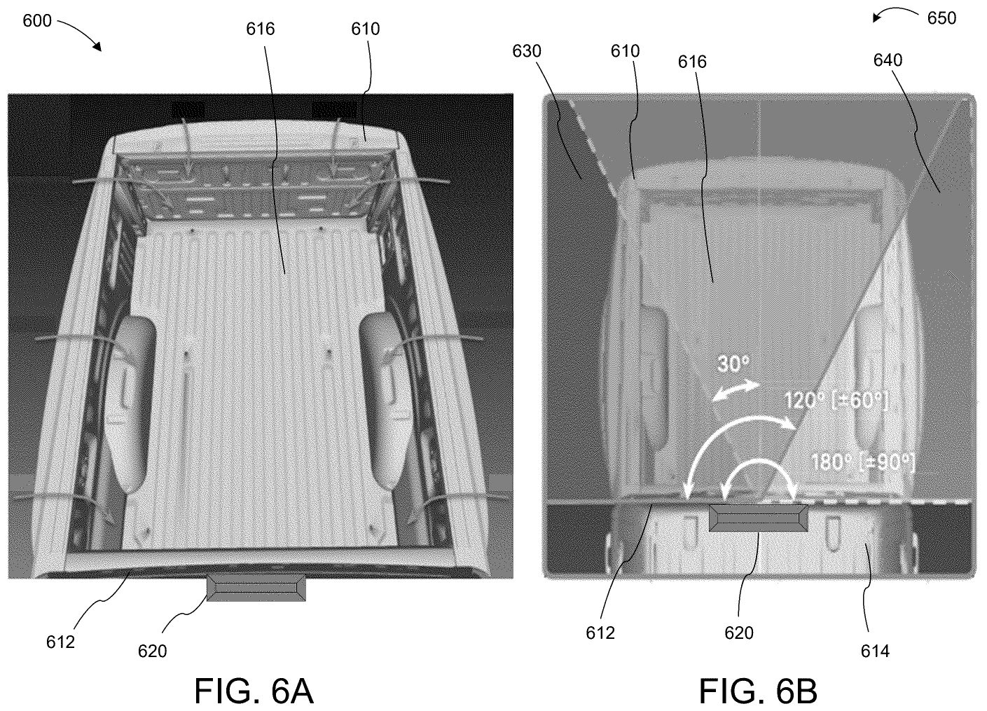

FIGS. 6A and 6B illustrate example images 600 and 650 of a point of view from the monitoring and detection device 620. The images 600 and 650 of FIGS. 6A and 6B, respectively, may display a point of view from the monitoring and detection device 620 when the device 620 is mounted to a vertical surface 612 of a vehicle 610. The monitoring and detection device 620, the vertical surface 612, and the vehicle 610 may be the monitoring and detection device 410, vertical surface 420, and vehicle 400 of FIG. 4, respectively. The images 600 and 650 of FIGS. 6A and 6B, respectively, may display the luggage compartment 616 of vehicle 610 from the point of view of the monitoring and detection device 620. The luggage compartment 616 of vehicle 610 may be the luggage compartment 416 of vehicle 400 of FIG. 4. The monitoring and detection device 620 mounted to the vertical surface 612 of vehicle 610 may use one or more sensors to capture images 600 and 650 of vehicle 610 when performing surveillance and intrusion detection of the vehicle 610. The monitoring and detection device 620 may capture other images of the luggage compartment 616 of vehicle 610 when an intrusion is detected. The monitoring and detection device 620 may monitor the luggage compartment 616 of the vehicle 610 to safeguard any property, persons and objects that are stored in the luggage compartment 616 of the vehicle 610. If the monitoring and detection device 620 detects a threat intrusion occurring in the luggage compartment 616 of the vehicle 610, the monitoring and detection device 620 may analyze data of the luggage compartment 616 of vehicle 610 to determine if any property, persons and objects have been removed and added.

FIG. 6B illustrates an example image 650 displaying the viewpoint of the sensors of the monitoring and detection device 620 with respect to the luggage compartment 616 of vehicle 610. The monitoring and detection device 620 may a plurality of sensors. Each sensor of the monitoring and detection device 620 may be positioned to face in a different direction from the monitoring and detection device 620. For example, the monitoring and detection device 620 may include at least a first sensor and a second sensor. The first sensor of the monitoring and detection device 620 may face 30 degrees to the left of the luggage compartment 616 from the center of the monitoring and detection device 620. The first sensor may have a field of view 630 of the luggage compartment 616 of vehicle 610. The field of view 630 of the first sensor may be 120 degrees. The second sensor of the monitoring and detection device 620 may face 30 degrees to the right of the luggage compartment 616 from the center of the monitoring and detection device 620. The second sensor may have a field of view 640 of the luggage compartment 616 of vehicle 610. The field of view 640 of the second sensor may be 120 degrees. The field of view 630 of the first sensor and the field of view 640 of the second sensor may have a 60 degree overlap of the luggage compartment 616 from the center of the monitoring and detection device 620. In this way, the combined field of view of the first and second sensors of the monitoring and detection device 620 may be 180 degrees, thus allowing the monitoring and detection device 620 to adequately monitor and detect intrusions occurring at the luggage compartment 616 of vehicle 610.

In another example, the monitoring and detection device 620 may also include two additional sensors, such as, for example, a third sensor and a fourth sensor, that may be used to monitor and detect intrusions occurring at the passenger compartment 614 of vehicle 610. The third sensor of the monitoring and detection device 620 may face 30 degrees to the left of the passenger compartment 614 from the center of the monitoring and detection device 620. The third sensor may have a field of view of 120 degrees of the left side of the passenger compartment 614 of vehicle 610. The fourth sensor of the monitoring and detection device 620 may face 30 degrees to the right of the passenger compartment 614 from the center of the monitoring and detection device 620. The fourth sensor may have a field of view of 120 degrees of the right side of the passenger compartment 614 of vehicle 610. The field of view of the third sensor and the field of view of the fourth sensor may have a 60 degree overlap of the passenger compartment 614 from the center of the monitoring and detection device 620. In this way, the combined field of view of the third and fourth sensors of the monitoring and detection device 620 may be 180 degrees, thus allowing the monitoring and detection device 620 to adequately monitor and detect intrusions occurring at the passenger compartment 614 of vehicle 610. Many variations are possible.

The monitoring and detection device 620 may be mounted at any location on a vertical surface of a vehicle, such as, for example, the center of vertical surface 612 of vehicle 610. Depending on the location and type of vehicle surface that the monitoring and detection device 620 is mounted to and also the position of the vehicle surface where the monitoring and detection device 620 is mounted on, one or more calibrations may be made to the monitoring and detection device 620 to allow the one or more sensors to adequately monitor and detect intrusions that may occur at all areas in and around the vehicle 610. One or more calibrations may also be made to the monitoring and detection device 620 according to the specifications of the vehicle 610 to ensure that the one or more sensors may adequately monitor and detect intrusions that may occur at all areas in and around the vehicle 610.

The one or more calibrations may be automatically performed by the monitoring and detection device 620 after the monitoring and detection device 620 is mounted to a vertical surface of the vehicle 610. The monitoring and detection device 620 may determine the one or more calibrations to be made according to an analysis conducted by the monitoring and detection device 620 of its location with respect to the entire vehicle 610, including, for example, the passenger compartment 614 and the luggage compartment 616. The monitoring and detection device 620 may determine the one or more calibrations to be made according to an analysis conducted by the monitoring and detection device 620 of the specifications of the vehicle 610, including, for example, the length, width, height, and overall size of the passenger compartment 614, the luggage compartment 616, and the vehicle 610 as a whole. The specifications of the vehicle 610 may be determined by the monitoring and detection device 620 by performing a scan of the entire vehicle. The specifications of the vehicle 610 may be determined by the monitoring and detection device 620 from a database of vehicle specifications. The specifications of the vehicle 610 may be determined by the monitoring and detection device 620 by retrieving input data of the vehicle from an application of a user device of the owner of vehicle 610. Many variations are possible.

FIG. 7 illustrates an example computing component 700 that includes one or more hardware processors 702 and machine-readable storage media 704 storing a set of machine-readable/machine-executable instructions that, when executed, cause the hardware processor(s) 702 to perform an illustrative method of monitoring and detecting unauthorized access to a vehicle. It should be appreciated that there can be additional, fewer, or alternative steps performed in similar or alternative orders, or in parallel, within the scope of the various examples discussed herein unless otherwise stated. The computing component 700 may be implemented as the computing component 110 of FIG. 1, the monitoring and detection circuit 210 of FIG. 2 and the computing component 800 of FIG. 8.

At step 706, the hardware processor(s) 702 may execute machine-readable/machine-executable instructions stored in the machine-readable storage media 704 to receive surveillance data of a vehicle. A vehicle may be used as a means of storage and transportation of objects, both living (e.g., animals, insects, plants, etc.) and inanimate objects (e.g., furniture, clothes, books, appliances, etc.), as well as a means of transportation of persons. The vehicle may include, for example, an automobile, truck, motorcycle, bicycle, scooter, moped, recreational vehicle and other like on- or off-road vehicles. The vehicle may include, for example, an autonomous, semi-autonomous and manual operation. The vehicle may include one or more devices that may be used to monitor the vehicle and detect any intrusions to the vehicle. A device may be implemented on a vertical facing surface of the vehicle, including, for example, the surface of a vertical internal frame, the surface of a vertical external frame, the surface of a rear window, etc. of the vehicle. Many variations are possible.

A device may include one or more sensors that may be used to collect data of the surveillance of the vehicle. The sensors may include, for example, a radar sensor, camera, image sensor, light detection and ranging (LiDAR) sensor, position sensor, audio sensor, infrared sensor, microwave sensor, optical sensor, haptic sensor, magnetometer, communication system and global positioning system (GPS). A radar sensor may include, for example, a pulsed radar, continuous wave radar, frequency modulated continuous wave (FMCW) radar (e.g., Infineon 60 GHz BGT60TR13C radar), bistatic radar, doppler radar, monopulse radar, passive radar, instrumentation radar, mapping radar, search radar, etc. Data may be received by at least one sensor of the device. The data of the surveillance of the vehicle may include information on persons, objects and other vehicles within a vicinity of the vehicle, including within and outside the vehicle. Many variations are possible.

At step 708, the hardware processor(s) 702 may execute machine-readable/machine-executable instructions stored in the machine-readable storage media 704 to detect an intrusion to the vehicle by an entity. The data of the surveillance of the vehicle may be analyzed by the device upon being collected by at least one sensor of the device. Analyzing the data of the surveillance of the vehicle may detect one or more intrusions to the vehicle by one or more entities. An intrusion to the vehicle may include, for example, when an entity comes within a particular vicinity of the vehicle. The particular vicinity of the vehicle may be within a distance threshold from the vehicle. The distance threshold may be preset. The distance threshold may vary according to the location of the vehicle, such as, for example, the vehicle is stationary in a parking garage, side of the road, open lot, etc. The distance threshold may be updated according to algorithms and models using security data of vehicles. An entity may include persons, objects and other vehicles not already associated with the vehicle. An entity may be associated with the vehicle when the entity is contained within the vehicle prior to the surveillance of the vehicle by the device. Many variations are possible.

At step 710, the hardware processor(s) 702 may execute machine-readable/machine-executable instructions stored in the machine-readable storage media 704 to transition a sensor out of a minimal power state upon detecting the intrusion to the vehicle. When the device for monitoring the surveillance and detecting intrusions to the vehicle is first initiated, the device may implement a minimal power state to its one or more sensors. The sensors being in a minimal power state may allow the sensors to be active and functioning for longer durations. The sensors being in a minimal power state may also limit the abilities and functions of the sensors to lower the amount of power being consumed by the sensors, thus allowing the sensors to be active and functioning for longer durations.

The sensors may stay in a minimal power state until the sensors are woken up and transitioned out of the minimal power state. Detecting an intrusion to the vehicle by an entity may cause the device to transition the one or more sensors of the device out of the minimal power state. When the sensors are out of the minimal power state, the sensors may be fully functional with all of its abilities and functions. The sensors may also consume more power when out of the minimal power state and be active and functioning for shorter durations. To preserve power and maintain optimal durations of use of the sensors, the device may transition the sensors back to the minimal power state when an intrusion is no longer detected and when an intrusion is determined to be authorized.

At step 712, the hardware processor(s) 702 may execute machine-readable/machine-executable instructions stored in the machine-readable storage media 704 to perform a scan of the vehicle to obtain information indicating a type of the intrusion. After the sensors have transitioned out of the minimal power state, the sensors may have full functionality and additional functions to allow the sensors to perform a scan of the vehicle. The sensors may perform a scan of the vehicle and everything inside and outside of the vehicle that is within a vicinity of the vehicle. The vicinity of the vehicle that the scan of the sensors may cover may be preset. The vicinity of the vehicle may vary according to the location of the vehicle, such as, for example, the vehicle is stationary in a parking garage, side of the road, open lot, etc. The vicinity of the vehicle may be updated according to algorithms and models using security data of vehicles. The vicinity of the vehicle may be the same as the distance threshold from the vehicle that is used to detect the occurrence of an intrusion to the vehicle. Performing a scan of the vehicle may allow the sensors to obtain information about the intrusion that is occurring to the vehicle, including, for example, information on the one or more entities causing the intrusion, information on the actions that the one or more entities are performing, etc. Many variations are possible.

The information about the intrusion may be analyzed to determine the type of the intrusion. The type of the intrusion may include, for example, a safe intrusion and a threat intrusion. A safe intrusion may be an intrusion caused by an entity who is authorized to access the vehicle. A safe intrusion may be an intrusion caused by an entity that is identified to be harmless to the vehicle. A threat intrusion may be an intrusion caused by an entity that is identified as being unauthorized to access the vehicle. A threat intrusion may be an intrusion caused by an entity that is identified as being harmful to the vehicle. Many variations are possible.

At step 714, the hardware processor(s) 702 may execute machine-readable/machine-executable instructions stored in the machine-readable storage media 704 to determine the type of the intrusion to the vehicle is a threat intrusion. As the sensors of the device for monitoring the surveillance and detecting intrusions to the vehicle is performing a scan of the vehicle, the sensors may collect information about the intrusion that is occurring to the vehicle. The information about the intrusion may include, for example, information on the one or more entities causing the intrusion, information on the actions that the one or more entities are performing, etc. The information about the intrusion may be analyzed to determine the type of the intrusion, such as, for example, a safe intrusion or a threat intrusion.

To determine the type of the intrusion is a threat intrusion, the information about the intrusion obtained from the scan may be analyzed. The information about the intrusion may be analyzed to first identify the one or more entities causing the intrusion to the vehicle. In one example, each of the one or more entities may be identified as a person, animal, object, etc. An entity may be identified by analyzing the information about the intrusion to obtain the identity of the entity, such as, for example, the facial recognition of the entity. After an entity is identified, it may be determined if the entity is unauthorized to access the vehicle. Determining if the entity is unauthorized to access the vehicle may include analyzing the entity's identification using ML algorithms, models, databases, servers, and the like to determine the entity's identification does not match the identify of an authorized entity to access the vehicle. Such ML algorithms, models, databases, servers, etc. may include information, such as, for example, facial recognition, of entities that are authorized to access the vehicle. In another example, the information about the intrusion may be analyzed to determine if at least one of the one or more entities causing the intrusion is a person. If at least one of the one or more entities causing the intrusion is determined to be a person, it may be determined that all of the one or more entities causing the intrusion are unauthorized entities. Many variations are possible.

Upon determining at least one entity is an unauthorized entity, the information about the intrusion may be further analyzed to determine if the unauthorized entity is performing an unauthorized action to the vehicle. In one example, if at least one entity is determined to be unauthorized based on the analysis of the entity's identification, it may be determined if the entity is performing an unauthorized action to the vehicle. An unauthorized action may include, for example, entering the vehicle, climbing on the vehicle, damaging the vehicle, removing items from the vehicle, and placing items into the vehicle. When it is determined that an unauthorized entity is performing an unauthorized action to the vehicle, then the type of the intrusion may be determined to be a threat intrusion. If the entity is determined to be authorized based on the analysis of the entity's identification, then the type of the intrusion may be determined to be a safe intrusion. If the entity is determined to be unauthorized, but it is determined that the unauthorized entity is not performing an unauthorized action to the vehicle, then the type of the intrusion may be determined to be a safe intrusion. Many variations are possible.

At step 716, the hardware processor(s) 702 may execute machine-readable/machine-executable instructions stored in the machine-readable storage media 704 to perform a safety action to interfere with the threat intrusion. Upon determining the type of the intrusion to be a threat intrusion, one or more safety actions may be performed. A safety action may include, for example, recording the intrusion, sounding an alarm, flashing lights, playing sounds, sending an alert, and shining projections. Recording the intrusion may include, for example, at least one of recording a video, taking photos, recording audio, etc. The safety action may be performed by the device for monitoring the surveillance and detecting intrusions to the vehicle. The safety action may be performed by the vehicle that the device for monitoring the surveillance and detecting intrusions to the vehicle is associated to. The safety action of an alert may also be sent to another device (e.g., a user device of the vehicle owner) and network/system (e.g., police network, home network, work network, vehicle security network, etc.) to notify of the threat intrusion. The alert may include, for example, a message, recordings, sounds, GPS location, identifications, etc. of information regarding the threat intrusion to the vehicle. Many variations are possible.

In this way, active surveillance may be performed on a vehicle to properly monitor and detect the occurrence of any intrusions on the vehicle. This may be beneficial to vehicle owners by increasing the security and protection of a vehicle and any property, persons and objects left within the vehicle. The active detection and response to unauthorized intrusions and access to a vehicle may also deter break ins, theft, vandalism, and other inappropriate acts to be performed to a vehicle. The active detection and response to unauthorized intrusions and access to a vehicle may also increase the likelihood of criminals to be caught and punished for their crimes.

As used herein, the terms circuit, system, and component might describe a given unit of functionality that can be performed in accordance with one or more applications of the present application. As used herein, a component might be implemented utilizing any form of hardware, software, or a combination thereof. For example, one or more processors, controllers, ASICS, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software (such as user device applications described herein), these software elements can be implemented to operate with a computing or processing component capable of carrying out the functionality described with respect thereto. One such example computing component is shown in FIG. 8. Various applications are described in terms of this example-computing component 800. After reading this description, it will become apparent to a person skilled in the relevant art how to implement the application using other computing components or architectures.

Referring now to FIG. 8, computing component 800 may represent, for example, computing or processing capabilities found within a device (such as device 150), vehicle (such as vehicle 400), self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, portable computing devices, and other electronic devices that might include some form of processing capability. In another example, a computing component might be found in components making up device 150, device 200, vehicle 400, device 420, monitoring and detection circuit 210, decision and control circuit 203, computing system 100, device 620, etc.

Computing component 800 might include, for example, one or more processors, controllers, control components, or other processing devices. This can include a processor, and any one or more of the components making up device 150 of FIG. 1, device 200 of FIG. 2, monitoring and detection circuit 210 of FIG. 2, device 420 of FIG. 4 and device 620 of FIG. 6. Processor 804 might be implemented using a general-purpose or special-purpose processing engine such as, for example, a microprocessor, controller, or other control logic. The processor 804 might be specifically configured to execute one or more instructions for execution of logic of one or more circuits described herein, such as monitoring and detection circuit 210 and decision and control circuit 303. Processor 804 may be configured to execute one or more instructions for performing one or more methods, such as the method described in FIG. 7.

Processor 804 may be connected to a bus 802. However, any communication medium can be used to facilitate interaction with other components of computing component 800 or to communicate externally. In applications, processor 804 may fetch, decode, and execute one or more instructions to control processes and operations for enabling monitoring and detection servicing as described herein. For example, instructions can correspond to steps for performing one or more steps of the method described in FIG. 7.

Computing component 800 might also include one or more memory components, simply referred to herein as main memory 808. For example, random access memory (RAM) or other dynamic memory, might be used for storing information and instructions to be fetched, decoded, and executed by processor 804. Such instructions may include one or more instructions for execution of one or more logical circuits described herein. Instructions can instructions 209 of FIG. 2 as described herein, for example. Main memory 808 might also be used for storing temporary variables or other intermediate information during execution of instructions to be fetched, decoded, and executed by processor 804. Computing component 800 might likewise include a read only memory (“ROM”) or other static storage device coupled to bus 802 for storing static information and instructions for processor 804.

The computing component 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a solid-state drive, a magnetic tape drive, an optical drive, a compact disc (CD) or digital video disc (DVD) drive (R or RW), or other removable or fixed media drive might be provided. Storage media 814 might include, for example, a hard disk, an integrated circuit assembly, magnetic tape, cartridge, optical disk, a CD or DVD. Storage media 814 may be any other fixed or removable medium that is read by, written to or accessed by media drive 812. As these examples illustrate, the storage media 814 can include a computer usable storage medium having stored therein computer software or data.

In alternative applications, information storage mechanism 810 might include other similar instrumentalities for allowing computer programs or other instructions or data to be loaded into computing component 800. Such instrumentalities might include, for example, a fixed or removable storage unit 822 and an interface 820. Examples of such storage unit 822 and interface 820 can include a program cartridge and cartridge interface, a removable memory (for example, a flash memory or other removable memory component) and memory slot. Other examples may include a PCMCIA slot and card, and other fixed or removable storage units 822 and interfaces 820 that allow software and data to be transferred from storage unit 822 to computing component 800.

Computing component 800 might also include a communications interface 824. Communications interface 824 might be used to allow software and data to be transferred between computing component 800 and external devices. Examples of communications interface 824 might include a modem or softmodem, a network interface (such as Ethernet, network interface card, IEEE 802.XX or other interface). Other examples include a communication port (such as for example, a USB port, IR port, RS232 port Bluetooth® interface, or other port), or other communications interface. Software/data transferred via communications interface 824 may be carried on signals, which can be electronic, electromagnetic (which includes optical) or other signals capable of being exchanged by a given communications interface 824. These signals might be provided to communications interface 824 via a channel 828. Channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 808, storage unit 822, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

As described herein, vehicles can be flying, partially submersible, submersible, automotives, boats, roadway, off-road, passenger, truck, trolley, train, drones, motorcycle, bicycle, or other vehicles. As used herein, vehicles can be any form of powered or unpowered transport. Intrusions to a vehicle can include the presence of at least one entity within a distance threshold of a vehicle. An intrusion to a vehicle may be unauthorized and detected as a threat when at least one entity causing the intrusion does not match the identity of an authorized entity to access the vehicle. The intrusion may be detected as a threat it is determined the unauthorized entity is performing an unauthorized action to the vehicle. An unauthorized action may include at least one of entering the vehicle, climbing on the vehicle, damaging the vehicle, removing items from the vehicle, and placing items into the vehicle.

The term “operably connected,” “coupled”, or “coupled to”, as used throughout this description, can include direct or indirect connections, including connections without direct physical contact, electrical connections, optical connections, and so on.

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, or C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof. While various applications of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various applications be implemented to perform the recited functionality in the same order, and with each of the steps shown, unless the context dictates otherwise.

Although the disclosed technology is described above in terms of various exemplary applications and implementations, it should be understood that the various features, aspects and functionality described in one or more of the individual applications are not limited in their applicability to the particular application with which they are described, but instead can be applied, alone or in various combinations, to one or more of the other applications of the disclosed technology, whether or not such applications are described and whether or not such features are presented as being a part of a described application. Thus, the breadth and scope of the technology disclosed herein should not be limited by any of the above-described exemplary applications.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various applications set forth herein are described in terms of exemplary block diagrams, flow charts and other illustrations. As will become apparent to one of ordinary skill in the art after reading this document, the illustrated applications and their various alternatives can be implemented without confinement to the illustrated examples. For example, block diagrams and their accompanying description should not be construed as mandating a particular architecture or configuration.

What is claimed is:

1. A method for monitoring and detecting unauthorized access to a vehicle, the method comprising:
receiving, by a sensor, surveillance data of the vehicle;
detecting, from the surveillance data, an intrusion to the vehicle by an entity;
transitioning the sensor out of a minimal power state upon detecting the intrusion to the vehicle;
performing, using the sensor, a scan of the vehicle to obtain information indicating a type of the intrusion;
determining, from the scan, the type of the intrusion to the vehicle is a threat intrusion; and
performing a safety action to interfere with the threat intrusion.

2. The method of claim 1, wherein the sensor is to be located on an apparatus for monitoring and detecting unauthorized access to the vehicle.

3. The method of claim 2, wherein the apparatus is to be located on a vertical surface of the vehicle.

4. The method of claim 1, wherein the sensor comprises at least one of radar sensor, camera, image sensor, light detection and ranging (LiDAR) sensor, position sensor, audio sensor, infrared sensor, microwave sensor, optical sensor, haptic sensor, magnetometer, communication system and global positioning system (GPS).

5. The method of claim 1, wherein the detecting the intrusion to the vehicle by the entity comprises determining, from the surveillance data, the entity is within a distance threshold from the vehicle.

6. The method of claim 1, wherein the determining the type of the intrusion is a threat intrusion comprises:
identifying, from the scan, the entity causing the intrusion to the vehicle;
determining the entity is unauthorized based on the entity identification; and
determining the entity is performing an unauthorized action to the vehicle.

7. The method of claim 6, wherein the determining the entity is unauthorized comprises:
analyzing the entity identification using Machine Learning (ML) algorithms; and
determining the entity identification does not match the identity of an authorized entity to access the vehicle.

8. The method of claim 6, wherein the unauthorized action comprises at least one of entering the vehicle, climbing on the vehicle, damaging the vehicle, removing items from the vehicle, and placing items into the vehicle.

9. The method of claim 1, wherein the safety action comprises at least one of recording the intrusion, sounding an alarm, flashing lights, playing sounds, sending an alert, and shining projections.

10. An apparatus for monitoring and detecting unauthorized access to a vehicle, the apparatus comprising:
a sensor configured to:
receive surveillance data of the vehicle; and
perform a scan of the vehicle to obtain information indicating a type of an intrusion;
a processor configured to:
detect, from the surveillance data, the intrusion to the vehicle by an entity;
transition the sensor out of a minimal power state upon detecting the intrusion to the vehicle; and
determine, from the scan, the type of the intrusion to the vehicle is a threat intrusion; and
a controller configured to:
perform a safety action to interfere with the threat intrusion.

11. The apparatus of claim 10, wherein the apparatus is to be located on a vertical surface of the vehicle.

12. The apparatus of claim 10, wherein the sensor comprises at least one of a radar sensor, camera, image sensor, light detection and ranging (LiDAR) sensor, position sensor, audio sensor, infrared sensor, microwave sensor, optical sensor, haptic sensor, magnetometer, communication system and global positioning system (GPS).

13. The apparatus of claim 10, wherein the determine the type of the intrusion is a threat intrusion comprises:
identifying, from the scan, the entity causing the intrusion to the vehicle;
determining the entity is unauthorized based on the entity identification; and
determining the entity is performing an unauthorized action to the vehicle.

14. The apparatus of claim 13, the determining the entity is unauthorized comprises:
analyzing the entity identification using Machine Learning (ML) algorithms; and
determining the entity identification does not match the identity of an authorized entity to access the vehicle.

15. The apparatus of claim 13, wherein the unauthorized action comprises at least one of entering the vehicle, climbing on the vehicle, damaging the vehicle, removing items from the vehicle, and placing items into the vehicle.

16. The apparatus of claim 10, wherein the safety action comprises at least one of recording the intrusion, sounding an alarm, flashing lights, playing sounds, sending an alert, and shining projections.

17. A system for monitoring and detecting unauthorized access to a vehicle, the system comprising:
one or more processors; and
memory coupled to the one or more processors to store instructions, which when executed by the one or more processors, cause the one or more processors to perform operations, the operations comprising:
receiving, by a sensor, surveillance data of the vehicle;
detecting, from the surveillance data, an intrusion to the vehicle by an entity;
transitioning the sensor out of a minimal power state upon detecting the intrusion to the vehicle;
performing, using the sensor, a scan of the vehicle to obtain information indicating a type of the intrusion;
determining, from the scan, the type of the intrusion to the vehicle is a threat intrusion; and
performing a safety action to interfere with the threat intrusion.

18. The system of claim 17, wherein the determining the type of the intrusion is a threat intrusion comprises:
identifying, from the scan, the entity causing the intrusion to the vehicle;
determining the entity is unauthorized based on the entity identification; and
determining the entity is performing an unauthorized action to the vehicle.

19. The system of claim 18, wherein the determining the entity is unauthorized comprises:
analyzing the entity identification using Machine Learning (ML) algorithms; and
determining the entity identification does not match the identity of an authorized entity to access the vehicle.

20. The system of claim 18, wherein the unauthorized action comprises at least one of entering the vehicle, climbing on the vehicle, damaging the vehicle, removing items from the vehicle, and placing items into the vehicle.
